(19) United States
(12) Patent Application Publication
(10) Pub. No.: US 2017/0208801 A1
(43) Pub. Date: Jul. 27, 2017

(54) LOW VOLATILITY PROMOTING WATER CONDITIONING ADJUVANTS

(71) Applicant: Adjuvants Unlimited LLC, Memphis, TN (US)

(72) Inventors: Kevin Crosby, Germantown, TN (US); Mickey R. Brigance, Germantown, TN (US); Jennifer Jordan-Bear, Cordova, TN (US); Shana Hall, Falkner, MS (US)

(73) Assignee: Adjuvants Unlimited LLC, Memphis, TN (US)

(21) Appl. No.: 15/329,156

(22) PCT Filed: Jul. 27, 2015
(86) PCT No.: PCT/US2015/042299

§ 371 Date: Jan. 25, 2017

Related U.S. Application Data
(60) Provisional application No. 62/028,888, filed on Jul. 25, 2014.

(51) Int. Cl. A01N 37/10; A01N 25/02; A01N 25/08; A01N 57/20

(52) U.S. Cl. CPC A01N 37/10; A01N 57/20; A01N 25/02; A01N 25/08

(57) ABSTRACT

Water conditioner compositions that do not promote the volatility loss of auxin containing herbicides are described. In addition to counteracting the effects of hard water on some herbicides, the compositions also act as a buffer to control pH of spray mixture formulations to between 5 and 10. Optionally other additives, such as surfactants, anti-drift agents, and/or defoamers can be included in the water conditioner compositions.

### CROSS-REFERENCE TO RELATED APPLICATIONS

This application is a national phase application under 35 U.S.C. §371 of international application PCT/US2015/042299 filed on Jul. 27, 2015, which claims the benefit of U.S. Provisional Application No. 62/028,888 filed on Jul. 25, 2014, and both are hereby incorporated by reference in their entirety for all that they teach.

### FIELD OF THE INVENTION

The present invention relates generally to water conditioning adjuvants that do not promote volatility of pesticide compositions comprising at least one auxin herbicide and optionally a second non-auxin herbicide and methods of preparing and using the same.

### BACKGROUND OF THE INVENTION

Auxin herbicides, such as dicamba (3,6-dichloro-2-methoxybenzoic acid) and 2,4-D (2,4-dichlorophenoxyacetic acid), are commonly used to control auxin-susceptible plant growth, both on agricultural and non-agricultural lands. Known problems associated with the auxin herbicides are volatility and drift. Volatility of some auxin herbicides can result in vaporization into the air during or after application to non-susceptible target crops, usually monocotyledons such as corn and other grains. The volatile auxin herbicides can then reach other crops by air currents and/or wind, thus causing damage to these auxin-susceptible crops such as soybeans, cotton, and fruits. Drift of the application spray of auxin herbicides may be due to both volatility and droplets on air currents reaching adjacent auxin-susceptible crops.

Others have used the approach of identifying auxin herbicide salts and/or formulations exhibiting lower volatility. For example, the diglycolamine salt of dicamba exhibits a lower volatility than the dimethylamine salt of dicamba. Although lower volatility auxin herbicide salts and formulations have been reported, further reduction in the volatility and off-target movement of auxin herbicides is still desirable, especially in dual-active herbicide formulations containing auxin herbicides and a second non-auxin herbicide, such as glyphosate or glufosinate.

Additionally, when auxin herbicides are either tank-mixed or co-formulated with a second non-auxin herbicide such as glyphosate or glufosinate, water hardness, in the form of dissolved calcium, magnesium, iron, aluminum or other cationic species, can reduce the effectiveness of the second non-auxin herbicide. It is known that water hardness reduces the efficacy of glyphosate and other non-auxin herbicides, and several commercial water conditioners are sold to minimize the deleterious effect of water soluble cations on glyphosate and these other non-auxin herbicides. A common water conditioner, especially recommended for use with glyphosate containing herbicides, is ammonium sulfate (also referred to herein as “AMS”). However, ammonium ions in a spray tank have been demonstrated to dramatically increase the volatility of auxin herbicides such as dicamba.

Accordingly, auxin herbicide spray formulations which include a second non-auxin herbicide that is sensitive to water hardness (such as glyphosate) would benefit from additives that would simultaneously 1) not increase the volatility of an auxin herbicide component and 2) counteract the effect of hard water caused by cations such as calcium, magnesium, iron, and others on non-auxin herbicides. Current water conditioners based on ammonium sulfate do not meet both of these conditions.

Furthermore, an additional concern with auxin herbicides is volatility of the parent acid of the formulated salts. When the pH of a spray mixture is significantly reduced below neutral (for example to pH 3 to 4) the protonated, free acid form of the auxin herbicide predominates in solution and not the salt. The free acid form of dicamba is reported to be about 100 times more volatile than the diglycolamine salt. (See WO 2011/019652 A2, which is incorporated herein by reference.) Therefore, a water conditioner that does not lower the pH of the spray mixture significantly below neutral is needed. Some commercial water conditioners that are based on monocarbamide dihydrogen sulfate instead of volatility-promoting ammonium sulfate are known to significantly lower the pH of a spray mixture, which would create the free acid of dicamba in solution and thus promote volatility. See U.S. Pat. No. 7,247,602, which is incorporated herein by reference. Therefore, a buffering water conditioner additive that would also buffer and maintain pH of greater than about 5 in an auxin herbicide formulation or a formulation containing a second non-auxin herbicide would be useful.

### SUMMARY OF THE INVENTION

In one aspect, the present invention provides water conditioner compositions that may be added to an herbicide spray mixture prior to application. The disclosed water conditioner compositions comprise at least one tricarboxcylic acid or agriculturally acceptable salt thereof, and optionally mono, di- or triprotic mineral acids such as hydrochloric, sulfuric, or phosphoric acid or agriculturally acceptable salts thereof, and optionally urea complexes of sulfuric or hydrochloric acid such as monocarbamide dihydrogen sulfate or monocarbamide hydrogen chloride. The weight ratio of tricarboxylic acid, or salt thereof, to mineral acid may be from about 1:10 to about 10:1. Additional components of a water conditioner composition may include mineral bases for pH buffering, especially to be between 5 and 10, and preferably greater than 5.5, one or more defoamers, one or more biocides, and/or one or more anti-caking agents. The weight ratio of tricarboxylic acid, or salt thereof, to mineral base may be from about 1:10 to about 10:1. The mixture of acids (or salts thereof) with multiple ionizable groups allows for the creation of buffers with the mineral bases that are useful for solution pH control.

In some embodiments, the disclosed water conditioner compositions may be formulated either as liquid solutions or dry powders by selecting the proper acids or salts that are commercially available. Both dry and liquid formulations of the water conditioner compositions are provided. In some embodiments, the invention provides a water conditioner composition as described above that contains agriculturally useful surfactants, especially electrolyte tolerant surfactants such as alkylpolyglucosides, phosphate esters, sulfates, ether sulfates, diphenyl sulfonates and the like, or combinations thereof.

In another aspect, the invention provides compositions for and methods of controlling water hardness in spray mixtures. Addition of the water conditioners of the present invention to spray mixtures containing hard water (from about 1 to 3000 ppm of water hardness) at a range of about 0.01% to about 5% (v/v) water conditioner protects water hardness sensitive herbicides, such as glyphosate.

In another aspect, the invention provides compositions for and methods of controlling off-site movement via drift of an auxin herbicide by including one or more drift control additives such as polyacrylamide, guar, polyglycerol esters, and modified celluloses, or combinations thereof.

Further benefits of the present invention will be apparent to one skilled in the art from reading this patent application. The embodiments of the invention described in the following paragraphs are intended to illustrate the invention and should not be deemed to narrow the scope of the invention.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The present invention provides water conditioning compositions comprising a tricarboxylic acid or salt thereof, and optionally, a mono, di- or triprotic mineral acid or acidic complex such as monocarbamide dihydrogen sulfate or monocarbamide hydrogen chloride, or optionally a mineral base such as, without limitation, sodium or potassium hydroxide to form a buffer to control the pH of the concentrate and the resulting spray mix when diluted with water or another aqueous solution, and optional surfactants and auxiliaries such as defoamers, preservatives, and/or anti-caking agents. The tricarboxylic acid or tricarboxylates with the mineral base are formulated to control the pH (buffering) to be between 5 and 10 to reduce auxin volatility by limiting free-acid auxin molecules in solution. Preferably, the concentrate and spray mix compositions are formulated to control the pH (buffering) to be greater than 5.5. The compositions of the present invention have the dual properties of acting as an antidote to hard water (“water conditioning”) while also not increasing volatility of auxin herbicides when added to a spray solution/formulation containing an auxin herbicide and a second non-auxin herbicide, such as glyphosate or glufosinate.

It has been surprisingly discovered that the addition of a sufficient amount of the described water conditioner composition to an herbicidal spray mixture (e.g., a “tank mix,” “spray mix,” or “spray mixture”) results in no significant increase in the level of volatile auxin herbicide detected as determined by plant bioassay. This is in contrast to a detectable relative increase in auxin herbicide volatility when a traditional ammonium based water conditioner is added to the spray mix. A sufficient amount of the water conditioner composition can alternatively be added to an herbicidal composition concentrate (e.g., “premix” or “herbicidal concentrate”) to effectuate the no significant increase in auxin herbicide volatility when later mixed to application strength in a spray mix.

In one aspect, the present invention includes a water conditioner composition comprising a tricarboxylic acid or an agriculturally acceptable salt thereof. The water conditioner composition may be liquid or dry concentrate compositions/formulations. The term “agriculturally acceptable salt” refers to a salt comprising a cation that is known and accepted in the art for the formation of salts for agricultural or horticultural use. In one embodiment, the salt is a water-soluble salt. “Tricarboxylic acid” refers to a hydrocarbon or substituted hydrocarbon containing three carboxylic acid functional groups (i.e., R¹—(C(O)OH)₃), where R¹ is (a) a linear hydrocarbon containing from 3-18 carbon units or (b) a cyclic hydrocarbon containing 3-8 carbon units, either as aromatic or non-aromatic rings. In some embodiments, the water conditioner composition comprises at least one tricarboxylic acid.

“Tricarboxylate” refers to a salt (i.e., R²—(C(O)OH)₃M_{X}), wherein M is an agriculturally acceptable cation (e.g., an agriculturally acceptable alkali metal cation); X=1, 2, or 3; and R² is (a) a linear hydrocarbon containing from 3-18 carbon units or (b) a cyclic hydrocarbon containing 3-8 carbon units, either as aromatic or non-aromatic rings. In some embodiments, the water conditioner composition comprises at least one tricarboxylate salt, which in aqueous compositions may be present, in whole or in part, in dissociated form as a tricarboxylate anion and the corresponding alkali metal cations.

Representative tricarboxylic acids and tricarboxylates generally comprise a hydrocarbon or unsubstituted hydrocarbon selected from citric acid (2-hydroxypropane-1,2,3 tricarboxylic acid), isocitric acid 1-hydroxypropane-1,2,3 tricarboxylic acid, aconitic acid (prop-1-ene-1,2,3 tricarboxylic acid), propane-1,2,3-tricarboxylic acid, trimellitic acid (benzene-1,2,4-tricarboxylic acid), trimesic acid (benzene-1,3,5-tricarboxylic acid) or hemimellitic acid (benzene-1,2,3-tricarboxylic acid). Agriculturally acceptable salts can be made from reacting acceptable alkali metal ions with the acids prior to or after formulation in the water conditioner compositions of the present invention.

The water conditioner compositions of the present invention optionally may further comprise advantageous additives such as surfactants, drift reduction agents, freeze protectants, anti-foaming agents, UV protectants, antimicrobial preservatives, and/or other additives that are necessary or desirable to improve the performance, crop safety, or handling of the water conditioner compositions. All embodiments of the water conditioner compositions of the present invention do not contain any intentionally added sources of ammonium ion. Trace quantities of ammonium may be present as trace components of the raw materials used in preparation of the finished water conditioner compositions. Where possible, sources of ammonium ion should be avoided or kept at a minimum while preparing the water conditioner compositions.

In one embodiment, the water conditioner concentrate composition comprises: (a) Water; (b) Tricarboxylic Acid; (c) Phosphoric Acid; (d) Sodium Hydroxide; and (e) Potassium Hydroxide, wherein the tricarboxylic acid in the concentrate contains an amount of citric acid, or agriculturally acceptable salt thereof (such as sodium citrate), from about 0.25% to about 25% by weight of the concentrate.

In another embodiment, the water conditioner concentrate composition comprises: (a) Water; (b) Tricarboxylic Acid; (c) Phosphoric Acid; (d) Sodium Hydroxide; (e) Potassium Hydroxide; and (f) Alkylpolyglucoside, wherein the tricarboxylic acid in the concentrate contains an amount of citric acid, or agriculturally acceptable salt thereof (such as sodium citrate), from about 0.25% to about 25% by weight of the concentrate.

In another embodiment, the water conditioner concentrate composition comprises: (a) Tricarboxylic Acid; (b) Phosphoric Acid; (c) Sodium Hydroxide; (d) Potassium Hydroxide; (e) Alkylpolyglucoside; and (f) Polyacrylamide, wherein the tricarboxylic acid in the concentrate contains an amount of citric acid, or agriculturally acceptable salt thereof (such as sodium citrate), from about 0.25% to about 25% by weight of the concentrate.

In further embodiments, the tricarboxylic acid of the water conditioner concentrate composition may be selected from citric acid (2-hydroxypropane-1,2,3 tricarboxylic acid), isocitric acid 1-hydroxypropane-1,2,3 tricarboxylic acid, aconitic acid (prop- 1-ene-1,2,3 tricarboxylic acid), propane-1,2,3-tricarboxylic acid, trimellitic acid (benzene-1,2,4-tricarboxylic acid), trimesic acid (benzene-1,3,5-tricarboxylic acid), hemimellitic acid (benzene-1,2,3-tricarboxylic acid), agriculturally acceptable salts thereof, or combinations thereof

In further embodiments, the liquid water conditioner concentrate comprises a tricarboxylate salt. In another embodiment, the tricarboxylate salt is an alkali metal salt. In another embodiment, the tricarboxylate salt is a potassium salt, such as potassium citrate. In another embodiment, the tricarboxylate salt is a sodium salt, such as sodium citrate.

In further embodiments, the liquid water conditioner concentrate composition comprises a tricarboxylate salt that is formed in situ during the preparation of the liquid concentrate when the tricarboxylate acid is contacted with a neutralizing base, such as an alkali metal hydroxide. Although a specific order of addition of the components is not required to prepare the final compositions, the order of addition described above can be advantageous to reduce the heat generation resulting when the ingredients are combined. In one embodiment, the neutralizing base is potassium hydroxide. In another embodiment, the neutralizing base is sodium hydroxide.

One embodiment of the invention is directed to a water conditioner of the invention that is a dry concentrate composition comprising: (a) Tricarboxylic Acid; (b) Potassium Sulfate; (c) Potassium Acid Phosphate (potassium pentahydrogen bis(phosphate) phosphoric acid, potassium salt (2:1)); (d) Urea—Nonionic Surfactant Clathrate; and (e) Silica Flow Aid, wherein the tricarboxylic acid in the concentrate contains an amount of citric acid, or agriculturally acceptable salt thereof (such as sodium citrate), from about 0.25% to about 70% by weight of the concentrate.

In another embodiment, the dry concentrate composition comprises: (a) Tricarboxylic Acid; (b) Potassium Sulfate; (c) Potassium Acid Phosphate (potassium pentahydrogen bis(phosphate) phosphoric acid , potassium salt (2:1)); (d) Urea—Nonionic Surfactant Clathrate; (e) Silica Flow Aid; and (f) Polyacrylamide, wherein the tricarboxylic acid in the concentrate contains an amount of citric acid, or agriculturally acceptable salt thereof (such as sodium citrate), from about 0.25% to about 70% by weight of the concentrate.

In further embodiments, the tricarboxylic acid of the dry concentrate composition may be selected from citric acid (2-hydroxypropane-1,2,3 tricarboxylic acid), isocitric acid 1-hydroxypropane-1,2,3 tricarboxylic acid, aconitic acid (prop-l-ene-1,2,3 tricarboxylic acid), propane-1,2,3-tricarboxylic acid, trimellitic acid (benzene-1,2,4-tricarboxylic acid), trimesic acid (benzene-1,3,5-tricarboxylic acid), hemimellitic acid (benzene-1,2,3-tricarboxylic acid), agriculturally acceptable salts thereof, or combinations thereof.

In further embodiments, the dry concentrate composition comprises a tricarboxylate salt. In another embodiment, the tricarboxylate salt is an alkali metal salt. In another embodiment, the tricarboxylate salt is a potassium salt, such as potassium citrate. In another embodiment, the tricarboxylate salt is a sodium salt, such as sodium citrate.

In further embodiments, the dry concentrate composition is in the form of a dry powder.

In still further embodiments, the dry concentrate is in the form of dry granules.

In another aspect, the present invention includes an herbicidal spray mixture composition with a water conditioner as described above. The term “auxin herbicide” refers to an herbicide that functions as a mimic of the natural auxin plant growth hormone, such as indole acetic acid, thereby affecting plant growth regulation. Auxin herbicides, as unnatural analogues of the natural auxin, result in many unusual growth effects, leading to plant death. Examples of auxin herbicides that are suitable for use in the spray mixture of the present invention compositions include, without limitation, benzoic acid herbicides, phenoxy herbicides, pyridine carboxylic acid herbicides, pyridine oxy herbicides, pyrimidine carboxylic acid herbicides, quinoline carboxylic acid herbicides, and benzothiazole herbicides.

Specific examples of auxin herbicides include: Dicamba (3,6-dichloro-2-methoxy benzoic acid); 2,4-D (2,4-dichlorophenoxyacetic acid); 2,4-DB (4-(2,4-dichlorophenoxy) butanoic acid); Dichloroprop (2-(2,4-dichlorophenoxy)propanoic acid); MCPA ((4-chloro-2-methylphenoxy)acetic acid); MCPB (4-(4-chloro-2-methylphenoxy) butanoic acid); Aminopyralid (4-amino-3,6-dichloro-2-pyridinecarboxylic acid); Clopyralid (3,6-dichloro-2-pyridinecarboxylic acid); Fluoroxypyr ([(4-amino-3,5-dichloro-6-fluoro-2-pyridinyl)oxy]acetic acid); Triclopyr ([(3,5,6-trichloro-2-pyridinyl)oxy]acetic acid); Diclopyr; Mecoprop (2-(4-chloro-2-methylphenoxy) propanoic acid); Mecoprop-P; Picloram (4-amino-3,5,6-trichloro-2-pyridinecarboxylic acid); Quinclorac (3,7-dichloro-8-quinolinecarboxylic acid); and Aminocyclopyrachlor (6-amino-5-chloro-2-cyclopropyl-4-pyrimidinecarboxylic acid); including salts and esters thereof; racemic mixtures and resolved isomers thereof; and combinations thereof

In one embodiment, the herbicidal spray mixture composition comprises dicamba, or an agriculturally acceptable salt or ester thereof. Examples of suitable dicamba salts include the N,N-bis-[aminopropyl]methylamine, monoethanolamine, dimethylamine (e.g., BANVEL®, ORACLE®, etc.), isopropylamine, diglycolamine (e.g., CLARITY®, VANQUISH®, etc.), potassium, and sodium salts, and combinations thereof. Commercially available sources of dicamba, and its agriculturally acceptable salts, include those products sold under the trade names BANVEL®, CLARITY®, DIABLO®, DISTINCT, ORACLE®, VANQUISH®, and VISION®.

In another embodiment, the herbicidal spray mixture composition contains an agriculturally acceptable dicamba salt, wherein the salt is selected from the group consisting of N,N-bis-[aminopropyl]methylamine, monoethanolamine, dimethylamine, isopropylamine, diglycolamine, potassium, and sodium salts, and combinations thereof.

In another embodiment, the herbicidal spray mixture compositions comprise 2,4-D, or an agriculturally acceptable salt or ester thereof. Examples of suitable 2,4-D salts include the choline, dimethylamine, and isopropylamine salts, and combinations thereof. Examples of suitable 2,4-D esters include the methyl, ethyl, propyl, butyl (2,4-DB), and isooctyl esters, and combinations thereof. Commercially available sources of 2,4-D, and its agriculturally acceptable salts and esters, include those products sold under the trade names BARRAGE®, FORMULA 40®, OPT-AMINE®, and WEEDAR 64®.

In another embodiment, the herbicidal spray mixture compositions comprise an agriculturally acceptable 2,4-D salt, wherein the salt is selected from the group consisting of choline, dimethylamine, and isopropylamine salts, and combinations thereof.

In another embodiment, the herbicidal spray mixture compositions comprise an agriculturally acceptable 2,4-D ester, wherein the ester is selected from the group consisting of butyl (i.e., 2,4-DB) and isooctyl esters, and combinations thereof.

In another embodiment, the herbicidal spray mixture compositions comprise at least two auxin herbicides, for example, dicamba, or an agriculturally acceptable salt or ester thereof, and 2,4-D, or an agriculturally acceptable salt or ester thereof.

Throughout the remainder of the description of the invention, where reference is made to dicamba, or an agriculturally acceptable salt or ester thereof, one skilled in the art will understand that the principles of the present invention apply to auxin herbicides generally, including those described above and others known in the art, and that the present invention is not limited to herbicidal compositions containing dicamba, or an agriculturally acceptable salt or ester thereof.

All embodiments of the herbicidal spray mixture compositions of the present invention do not contain any intentionally added sources of ammonium ion. Trace quantities of ammonium may be present as trace components of the raw materials used in preparation of the finished herbicidal spray mixture compositions. Where possible, sources of ammonium ion should be avoided or kept at a minimum while preparing the herbicidal spray mixture compositions.

The herbicidal spray mixture compositions of the present invention optionally may further comprise at least one non-auxin herbicide. The term “non-auxin herbicide” refers to an herbicide having a primary mode of action other than as an auxin herbicide. Representative examples of non-auxin herbicides include acetyl CoA carboxylase (ACCase) inhibitors, acetolactate synthase (ALS) inhibitors, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvyl shikimate-3-phosphate (EPSP) synthase inhibitor, glutamine synthetase inhibitor, dihydropteroate synthetase inhibitor, mitosis inhibitors, and nucleic acid inhibitors; salts and esters thereof; racemic mixtures and resolved isomers thereof; and combinations thereof.

Representative examples of ACCase inhibitors include clethodim, clodinafop, fenoxaprop-P, fluazifop-P, quizalofop-P, and sethoxydim.

Representative examples of ALS or AHAS inhibitors include flumetsulam, imazamethabenz-m, imazamox, imazapic, imazapyr, imazaquin, imazethapyr, metsulfuron, prosulfuron, and sulfosulfuron.

Representative examples of photosystem I inhibitors include diquat and paraquat.

Representative examples of photosystem II inhibitors include atrazine, cyanazine, diuron, and metibuzin.

Representative examples of PPO inhibitors include acifluorofen, butafenacil, carfentrazone-ethyl, flufenpyr-ethyl, fluthiacet, flumiclorac, flumioxazin, fomesafen, lactofen, oxadiazon, oxyfluorofen, and sulfentrazone.

Representative examples of carotenoid biosynthesis inhibitors include aclonifen, amitrole, diflufenican, mesotrione, and sulcotrione.

A representative example of an EPSP inhibitor is N-phosphonomethyl glycine (glyphosate). Commercially available sources of glyphosate, and its agriculturally acceptable salts, include those products sold under the trade names DURANGO® DMA®, HONCHO PLUS®, ROUNDUP POWERMAX®, ROUNDUP WEATHERMAX®, TRAXION®, and TOUCHDOWN®.

A representative example of a glutamine synthetase inhibitor is glufosinate. Preferably, the glufosinate source is non-ammoniated.

A representative example of a dihydropteroate synthetase inhibitor is asulam.

Representative examples of mitosis inhibitors include acetochlor, alachlor, dithiopyr, S-metolachlor, and thiazopyr.

Representative examples of nucleic acid inhibitors include difenzoquat, fosamine, metham, and pelargonic acid.

In some embodiments, the herbicidal spray mixture compositions of the present invention contain an amount (acid equivalent weight) of the tricarboxylic acid, or tricarboxylate thereof, from about 0.01% to about 10% (v/v) of the tank mix for liquid water conditioner compositions and from about 0.01% to about 10% (w/v) for dry powder compositions of the water conditioners. In some embodiments, the amount is from about 0.05% to about 2% (v/v) of the tank mix liquid water conditioners and from about 0.05% to about 2% (w/v) for dry water conditioners. In some embodiments, the amount is from about 0.1% to about 1% (v/v) of the tank mix for liquid water conditioners and from about 0.1% to about 1% (w/v) for dry water conditioners. In some embodiments, the tricarboxylic acid, or tricarboxylate thereof, is citric acid, or agriculturally acceptable salt thereof.

In another aspect, the present invention includes methods of preparing the above water conditioning compositions and the herbicidal spray mixture compositions described above. In one embodiment, the methods of controlling the growth of auxin-susceptible plants comprise the steps of: (1) Preparing a herbicidal spray tank mixture composition comprising water, a source of auxin herbicide, and a water conditioning composition as described above; and (2) Applying an herbicidally effective amount of the herbicidal spray tank mixture composition to the auxin-susceptible plants (such as broadleaf plants and weeds and the like), wherein the herbicidal spray tank mixture composition contains an amount of water conditioner composition between 0.05% and 10%, preferably between 0.1% and 5%, and more preferably between 0.25% to 2%.

In another embodiment, the methods of controlling the growth of auxin-susceptible plants comprise the steps of: (1) Preparing a spray tank mixture composition comprising water, a source of auxin herbicide, a source of non-auxin herbicide (such as, without limitation glyphosate or glufosinate, or agriculturally acceptable salt thereof), and a water conditioning composition as described above; and (2) Applying a herbicidally effective amount of the spray tank mixture composition to the herbicide susceptible plants (such as broadleaf plants and weeds and/or monocot plants and grass weeds), wherein the spray tank mixture composition contains an amount of water conditioner composition between 0.05% and 10%, preferably between 0.1% and 5%, and more preferably between 0.25% to 2%.

In yet another aspect, the present invention includes methods of controlling (buffering) the pH of the above water conditioning compositions and the herbicidal spray mixture compositions described above to be between 5 and 10. In one embodiment, the methods of controlling the pH of the compositions comprise the steps of: (1) Preparing a herbicidal spray tank mixture composition comprising water and a source of auxin herbicide; and (2) Adding an effective dose of a water conditioning composition as described above. Preferably, the amount of water conditioner composition added is between 0.05% and 10%, more preferably between 0.1% and 5%, and even more preferably between 0.25% to 2% of the total, final conditioned herbicidal spray tank mixture composition. As used in this context, “effective dose” means the amount of a water conditioning composition as described above that will buffer the pH of the final conditioned herbicidal spray tank mixture composition to be between 5 and 10, and preferably to be greater than 5.5.

### EXAMPLES

The following non-limiting examples are provided to illustrate the utility of the present invention. It should be noted that the composition examples below are presented on the basis of the components initially combined to form the reported spray tank mixture. The various embodiments of the present invention may be combined in various ratios and orders of addition to maximize the performance of the water conditioner.

The water conditioner compositions tested in the Experiments herein are:

### Example 1

| | |
|---|---|
| Glycerin | 47.70 |
| Water | 2.00 |
| Phosphoric Acid (85%) | 16.00 |
| Citric Acid solution (50%) | 10.00 |
| Sodium Hydroxide (50%) | 13.00 |
| Antifoam | 0.30 |
| Alkylpolyglucoside | 11.00 |

### Example 2

| | |
|---|---|
| Glycerin | 5.00 |
| Water | 54.80 |
| Sodium Citrate | 12.15 |
| Monocarbamide Dihydrogen Sulfate | 7.15 |
| Sodium hydroxide (50%) | 5.70 |
| Alkylpolyglucoside | 15.00 |
| Antifoam | 0.10 |
| Preservative | 0.10 |

### Example 3

| | |
|---|---|
| Water | 40.3 |
| Alkylpolyglucoside | 15.0 |
| Sodium Citrate | 15.0 |
| Sodium Hydroxide (50%) | 7.5 |
| Potassium Hydroxide (45%) | 10.0 |
| Phosphoric Acid (85%) | 12.0 |
| Antifoam | 0.1 |
| Preservative | 0.1 |

Where a percentage (%) follows an ingredient it indicates this is an aqueous solution with the listed percentage of actual ingredient.

Water Conditioning

A field trial was conducted to examine the water conditioning capability of this invention. The formula in example two was chosen for this trial.

Trial details: Field plots were established at Agicenter International (Memphis, Tenn.). Plots consisted of 3 species: Amaranthus palmieri (Bayer code AMAPA), non-transgenic Glycine max (GLYMX) and Sorghum halapense (SORHA). The soil is a Memphis silt loam, (19.7% sand, 74.8% silt, 5.4% clay, 1.6% organic matter) managed with conventional tillage. Plot size was 6.3 feet wide and 20 feet long. The experimental design was a randomized complete block with 3 replications. Plots were sprayed with 10 gallons per acre spray solution through AIXR 8002 nozzles (Spraying Solutions Inc.).

Spray treatments: Herbicide spray mix 1 consisted of 0.75 pint/acre of 2,4-D dimethylamine salt (4 lb/gal) per plus 1.0 pint/acre of 41% IPA glyphosate plus 2.5 quarts of hard water concentrate/100 gallons to produce approximately 500 ppm water hardness with or without water conditioner (Example 2). Water conditioner of Example 2 was included at 0.5% (volume percent; equal to 2 quarts per 100 gallons of spray solution). Sprays were applied at the 4-8″ height of plant growth.

Results for plant control: Table 1 shows the results as percent control at 21 days after application.

TABLE 1
Percent control of three plant species 21 days
after application (average of 3 replicates).

| | Species | | |
|---|---|---|---|
| | AMAPA | GLYMX | SORHA |
| 2,4-D DMA, IPA | 40 | 40 | 90 |
| glyphosate + hard | | | |
| water concentrate | | | |
| 2,4-D DMA, IPA | 58.3 | 71.7 | 90 |
| glyphosate + hard | | | |
| water concentrate + | | | |
| Example 2 | | | |

These results show the addition of water conditioner formulation Example 2 improves the control of broadleaf species in the presence of hard water.

The herbicidal tank mix compositions disclosed in Experiments 1 and 2 were prepared using CLARITY® (DGA dicamba from BASF), and ROUNDUP POWERMAX® (potassium glyphosate from Monsanto), by successively adding each specified herbicide to water, mixing, and followed by the specified water conditioner composition. Those tank mix formulations containing additional tank mix adjuvants, such as ammonium sulfate (40% solution, American Plant Foods), were typically prepared by adding aqueous stock solutions of the adjuvants to the herbicide mixture.

Herbicidal tank mix compositions prepared by the method described above are listed in Table 2 and Table 3 below:

TABLE 2
Spray Mix (all components % by weight)

| | 1 | 2 | 3 | 4 | 5 | 6 |
|---|---|---|---|---|---|---|
| CLARITY © | 1.25 | 1.25 | 1.25 | 1.25 | 1.25 | 1.25 |
| ROUNDUP | 2.50 | 2.50 | 2.50 | 2.50 | | |
| POWERMAX © | | | | | | |
| Ammonium | | 1.02 | | | | 1.02 |
| Sulfate (AMS) | | | | | | |
| Example 1 | | | 0.5 | | | |
| Example 3 | | | | 0.5 | | |

TABLE 3
Spray mix (all components by % weight)

| | 1 | 2 | 3 | 4 | 5 | 6 |
|---|---|---|---|---|---|---|
| CLARITY © | 1.25 | 1.25 | 1.25 | 1.25 | 1.25 | 1.25 |
| ROUNDUP | 2.50 | 2.50 | | | | |
| POWERMAX © | | | | | | |
| Ammonium | | 1.02 | 1.02 | 1.02 | 1.02 | |
| Sulfate (AMS) | | | | | | |
| Example 3 | | | | 0.5 | 0.5 | |
| Example 2 | | | | | | 0.5 |

To measure the effect of additives on dicamba volatility, a plant bioassay was used. Tomato plants (cultivar ‘Big Boy’) were purchased locally at approximately four inch height and transplanted into styrofoam cups using STA-GREEN® potting mix with fertilizer (LF, LLC). Plants were held at ambient outdoor conditions and watered as needed. Within two days of transplanting, the plants were ready for bioassay.

Treatment Method

Two plants were used per assay tray. A flat tray without drainage openings (Hummert International part 11-3050-1) was used to hold the plants. A clear plastic lid (Hummert International part 14-3850-2) secured with six binder clips was used to cover the tray.

Four petri dish bottoms (100 mm Fisher Scientific) were each treated with a spray to deliver 73 milligrams of spray mix to the dish. The petri dish bottoms were immediately placed in the trays with the two tomato plants, the lid clamped over the tray with the binder clips and the assembled units were held for eight hours under outdoor ambient conditions without disturbance. After eight hours the lids were removed and disposed of, the petri dish bottoms were removed and disposed of, and the flats were arranged one foot apart. After 12-18 hours the plants were randomized among fresh flats and maintained under ambient outdoor conditions for 13-16 days, then rated for phytotoxicity on a 0-100 scale, where “0” means no visual effect/plant injury and “100” means plant death (expressed as % inhibition of growth compared to untreated control).

Results

TABLE 4
Results of Experiment 1. Phytotoxicity expressed as %
inhibition of growth compared to untreated control.
Spray Mix (from Table 2)

| | 1 | 2* | 3 | 4 | 5 | 6* |
|---|---|---|---|---|---|---|
| Plant 1 | 0 | 60 | 0 | 0 | 30 | 50 |
| Plant 2 | 0 | 60 | 20 | 0 | 10 | 70 |
| Average | 0 | 60 | 10 | 0 | 20 | 60 |

*Spray mix contains ammonium sulfate (AMS)

No phytotoxicity was observed with the CLARITY®/POWERMAX® combination (spray mix 1). However, the addition of AMS showed a dramatic increase in damage with typical auxin herbicide symptoms (stem distortion and/or stunting—spray mix 2). When Example 3 (containing tricarboxylic acid salt) was added to CLARITY®! POWERMAX®, no phytotoxicity was observed (spray mix 4). When Example 1 (low dose tricarboxylic acid) was the additive, slight damage was observed on one plant (spray mix 3). The dicamba alone mix showed some phytotoxicity (spray mix 5), but when ammonium sulfate was added to the dicamba only mix, a large increase in phytotoxicity was observed (spray mix 6).

TABLE 5
Results of Experiment 2. Phytotoxicity expressed as %
inhibition of growth compared to untreated control.
Spray Mix (from Table 3)

| | 1 | 2* | 3* | 4* | 5* | 6 |
|---|---|---|---|---|---|---|
| Plant 1 | 0 | 60 | 80 | 50 | 20 | 10 |
| Plant 2 | 0 | 50 | 60 | 80 | 70 | 15 |
| Average | 0 | 55 | 70 | 65 | 45 | 12.5 |

*Spray mix contains ammonium sulfate (AMS)

This experiment shows that the effect of AMS causes phytotoxicity due to volatility even in the presence of water conditioners. Dicamba+glyphosate (spray mix 1) showed no damage, but addition of AMS causes damage similar to experiment 1 (spray mix 2). Dicamba alone with AMS (spray mix 3) also showed high levels of damage. When Example 3 is added to CLARITY® plus AMS, the damage is the same as for CLARITY® plus AMS alone (spray mixes 4 vs 3, respectively). When Example 2 was added to dicamba+AMS it did not reverse the AMS induced phytotoxicity (spray mix 5), comparable to Example 3. Finally, when Example 2 was added to dicamba alone only very slight damage was noted (spray mix 6).

These two experiments show that water conditioners containing tricarboxylic acids or salts thereof do not prevent volatility damage caused by AMS plus dicamba; however, they do not significantly cause volatility induced damage when combined with dicamba or dicamba/glyphosate in a spray tank mixture when tested using a tomato plant bioassay.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

1. A water conditioner composition concentrate comprising:
a tricarboxylic acid, a salt thereof, or a combination of a tricarboxylic acid and a salt thereof; and optionally at least one mineral acid, selected from hydrochloric, sulfuric, phosphoric acid; and optionally at least one mineral base to buffer the pH of the concentrate to between 5 and 10,
wherein the concentrate comprises an amount of the tricarboxylic acid or salt thereof, sufficient to reduce the effect of dissolved hard water cations on the efficacy of herbicides sensitive to hard water without promoting volatility of auxin herbicides in an herbicide spray mixture composition.

2. The concentrate of claim 1, wherein the weight ratio of tricarboxylic acid and salt thereof is from about 1:10 to about 10:1.

3. The concentrate of claim 1, wherein the weight ratio of tricarboxylic acid, or salt thereof, to mineral acid is from about 1:10 to about 10:1.

4. The concentrate of claim 1, wherein the weight ratio of tricarboxylic acid, or salt thereof, to mineral base is from about 1:10 to 10:1.

5. The concentrate of claim 1, further comprising electrolyte tolerant surfactants alkylpolyglucoside, phosphate esters, sulfates, ether sulfates, diphenyl sufonates, ethylene oxide-propylene oxide block co-polymers, and urea clathrates of ethylene oxide-propylene oxide block co-polymers.

6. The concentrate of claim 1, further comprising drift control additives such as polyacrylamides, guar gums, lecithin, cellulose derivatives, complex carbohydrates, polymeric resins, and pine-derived resins.

7. The concentrate of claim 1, wherein the phosphoric acid is a potassium acid phosphate comprising potassium pentahydrogen bis(phosphate) phosphoric acid and potassium salt (2:1).

8. The concentrate of claim 1, wherein the pH of the concentrate is buffered to be greater than 5.5.

9. The concentrate of claim 1, wherein the mineral base is selected from the group consisting of sodium hydroxide and potassium hydroxide.

10. The concentrate of claim 1, wherein the concentrate is a dry (non-liquid) composition.

11. The concentrate of claim 1, wherein the concentrate is a liquid composition.

12. An herbicidal spray mixture composition comprising the concentrate of claim 1 and an auxin herbicide, wherein the pH of the herbicidal spray mixture composition is buffered to be between 5 and 10.

13. The herbicidal spray mixture composition of claim 11, wherein the auxin herbicide is dicamba, or an agriculturally acceptable salt or ester thereof.

14. The herbicidal spray mixture composition of claim 11, wherein the auxin herbicide is 2,4-D, or an agriculturally acceptable salt or ester thereof.

15. The herbicidal spray mixture composition of claim 11, wherein the auxin herbicide is a combination of dicamba, or an agriculturally acceptable salt or ester thereof, and 2,4-D, or an agriculturally acceptable salt or ester thereof

16. The herbicidal spray mixture composition of claim 11, further comprising a non-auxin herbicide.

17. The herbicidal spray mixture composition of claim 16, wherein the non-auxin herbicide is glyphosate, or an agriculturally acceptable salt thereof.

18. The herbicidal spray mixture composition of claim 16, wherein the non-auxin herbicide is glufosinate, or an agriculturally acceptable salt thereof.

19. The herbicidal spray mixture composition of claim 16, wherein the non-auxin herbicide is a combination of glyphosate, or an agriculturally acceptable salt thereof, and glufosinate, or an agriculturally acceptable salt thereof.

20. The herbicidal spray mixture composition of claim 11, wherein the pH of the herbicidal spray mixture composition is buffered to be greater than 5.5.

21. A method of controlling the growth of an auxin-susceptible plant, the method comprising the steps of:
(1) preparing an aqueous herbicidal spray tank mixture comprising an auxin herbicide, the concentrate of claim 1, and
(2) applying an herbicidally effective amount of the aqueous herbicidal spray tank mixture to the auxin-susceptible plant.

22. The method of claim 21, wherein the auxin herbicide comprises dicamba, or an agriculturally acceptable salt or ester thereof; 2,4-D, or an agriculturally acceptable salt or ester thereof; or combinations thereof.

23. The method of claim 21, wherein the auxin herbicide comprises dicamba, or an agriculturally acceptable salt or ester thereof.

24. The method of claim 21, wherein the auxin herbicide comprises 2,4-D, or an agriculturally acceptable salt or ester thereof.

25. The method of claim 21, wherein the aqueous herbicidal spray tank mixture further comprises a non-auxin herbicide.

26. The method of claim 25, wherein the non-auxin herbicide comprises glyphosate, or an agriculturally acceptable salt thereof;
glufosinate, or an agriculturally acceptable salt thereof; or combinations thereof.

27. The method of claim 25, wherein the non-auxin herbicide comprises glyphosate, or an agriculturally acceptable salt thereof

28. The method of claim 25, wherein the non-auxin herbicide comprises glufosinate, or an agriculturally acceptable salt thereof.

29. The method of claim 25, wherein the auxin herbicide comprises dicamba, or an agriculturally acceptable salt or ester thereof, and the non-auxin herbicide comprises glyphosate, or an agriculturally acceptable salt thereof.

30. The method of claim 25[[ 24]], wherein the application mixture comprises dicamba, or an agriculturally acceptable salt or ester thereof, and the non-auxin herbicide comprises glufosinate, or an agriculturally acceptable salt thereof.

31. The method of claim 25, wherein the auxin herbicide comprises 2,4-D, or an agriculturally acceptable salt or ester thereof, and the non-auxin herbicide comprises glyphosate, or an agriculturally acceptable salt thereof.

32. The method of claim 25, wherein the auxin herbicide comprises 2,4-D, or an agriculturally acceptable salt or ester thereof, and the non-auxin herbicide comprises glufosinate, or an agriculturally acceptable salt thereof.

33. A method of controlling the pH of the herbicidal spray mixture composition of claim 11 to be buffered between 5 and 10 comprising adding an effective dose of the concentrate of claim 1 in the amount of between about 0.05% to about 10% (v/v) to an aqueous solution comprising water.

34. The method of claim 33, wherein the amount of the concentrate is about 0.1% to about 5% (v/v).

35. The method of claim 33, wherein the amount of the concentrate is about 0.25% to about 2% (v/v).

36. The method of claim 33, wherein the pH of the herbicidal spray mixture composition is buffered to be greater than 5.5.
